(19) United States
(12) Patent Application Publication
(10) Pub. No.: US 2007/0179871 A1
(43) Pub. Date: Aug. 2, 2007

(54) System and Method for providing and utilizing cascading express asset capitalization integration rules

(76) Inventors: Earlena Fields Minor, Tracy, CA (US); Michael Joshua Hendricks, Tracy, CA (US)

Correspondence Address: TOWNSEND AND TOWNSEND AND CREW LLP, TWO EMBARCADERO CENTER, 8TH FLOOR, SAN FRANCISCO, CA, 94111-3834, US

(21) Appl. No.: 10/630,596

(22) Filed: Jul. 29, 2003

(51) Int. Cl. G06Q 40/00

(52) U.S. Cl. 705/35

(57) ABSTRACT

A system and method is provided which minimizes the amount of human intervention required to capitalize expenditures into assets. According to one embodiment, asset (capitalization) integration rules pertaining to automatic asset creation and capitalization is set at a business unit level. When a project is created within the business unit, these asset integration rules will automatically default to the project. Subsequently, when an activity is created within the project, the same set of asset integration rules will default from the project to the activity. A user has an ability to override the defaulted asset integration rules at both the project and activity levels. However, if no override is desired, there is no human intervention required.

### BACKGROUND OF THE INVENTION

1. Field of the Invention

The present invention relates generally to the field of asset capitalization and more particularly to a system and method for providing and utilizing cascading express asset capitalization integration rules.

2. Background of the Invention

The use of computerized systems for maintenance of material costs, labor, overhead, and other related expenses for business projects and activities is becoming increasingly popular. Many business entities desire the ability to have all of these expenses organized and stored in a central computerized location. Further, the capability of utilizing the stored information to create asset entries for further processing, such as for capitalization by a business entity's financial department, is highly desirable.

Disadvantageously, current asset creation systems are labor intensive. In some prior art systems, a user is required to enter asset definitions, relate these asset 20 definitions to projects and activities, and/or assign these projects and activities to a proper asset for every new entry. Unfortunately, asset creation criteria must be redefined for each of these new entries. Typically, a large corporation may have millions of entries in a single day. Thus, the labor required to set up and maintain information in the current systems is enormous.

Another disadvantage of some current asset creation systems is that asset creation is typically manual. Thus, a user must identify and correctly select proper rows of cost data at an appropriate time to create an asset (i.e., manually match and assign costs to assets and manually trigger asset creation). Therefore, current asset creation systems are not only time consuming to use, but are prone to data entry and human errors.

Further, the user may be required to manually determine if assets span financial years, and how to deal with these particular assets. Oftentimes, new entries post-capitalization (i.e., post asset creation) are difficult to manage.

Therefore, there exists a need for a highly automated way to capitalize assets requiring minimal user interaction.

### SUMMARY OF THE INVENTION

The present invention provides a system and method which minimizes the amount of human intervention required to capitalize expenditures into assets. According to one embodiment of the present invention, asset capitalization integration rules pertaining to automatic asset creation and capitalization is set at a business unit level. When a project is created within the business unit, these asset integration rules will automatically default or cascade to the project. Subsequently, when an activity is created within the project, the same set of asset integration rules will default or cascade from the project to the activity. A user has an ability to override the defaulted asset integration rules at both the project and activity levels. However, if no override is desired, there is no human intervention required.

In one embodiment of the present invention, the system comprises a capitalization module, an application engine, and a capitalization database. The capitalization database stores expenditure inputs and, in some embodiments, their corresponding asset integration rules. According to one embodiment, the application engine will integrate expenditures into related assets based on the asset integration rules at a predefined time. The resulting assets may then be sent to an asset management engine for further processing.

The capitalization module may comprise capitalization rules, integration triggers, adjustment triggers, end of year rules, and distribution rules. Each of these rules and triggers will be set at the business unit level and will be defaulted down through projects and activities created within the business unit. The capitalization rules determine a relationship between the activity and at least one asset. Depending on the capitalization rule selected, a distribution rule may need to be specified which indicates a relationship between the activity and a plurality of assets. The integration triggers determine timing for capitalization, while adjustment triggers determine treatment of expenditures after the asset has been capitalized. Finally, end of year rules specify how adjustments occur after close of a financial time period. Each of these rules or triggers may be modified by a user at a project or activity level.

### BRIEF DESCRIPTION OF THE DRAWINGS

FIG. 1 is a schematic diagram of an exemplary architecture utilizing a capitalization engine of the present invention;

FIG. 2 is block diagram of the exemplary capitalization engine in accordance with an embodiment of the present invention;

FIG. 3 is a flowchart illustrating a process for defining and applying asset capitalization integration rules in accordance with an embodiment of the present invention;

FIG. 4 is a flowchart illustrating a process for creating assets utilizing the asset capitalization integration rules;

FIG. 5 is a screen shot showing an exemplary asset transaction filter page in accordance with an embodiment of the present invention;

FIG. 6 is a screen shot showing an exemplary business unit asset options page in accordance with an embodiment of the present invention;

FIG. 7 is a screen shot showing an exemplary project asset options page in accordance with an embodiment of the present invention;

FIG. 8 is a screen shot showing an exemplary activity asset options page in accordance with an embodiment of the present invention; and

FIG. 9a-FIG. 9f are screen shots showing exemplary asset distribution pages in accordance with embodiments of the present invention.

### DESCRIPTION OF THE PREFERRED EMBODIMENT

The present system and method overcomes or substantially alleviates prior disadvantages associated with manual processes to capitalize assets constructed or maintained in computerized systems. Advantageously, the present invention minimizes the amount of human intervention required to capitalize expenditures into assets. Asset (capitalization) integration rules pertaining to automatic asset creation and capitalization is provided at a business unit level. These asset integration rules will default to each project created within the business unit upon creation. Subsequently, when an activity is created within the project, the asset integration rules will default from the project to the activity. A user has an ability to override the default asset integration rules at both the project and activity levels. However, if no override is desired, there is no human intervention required.

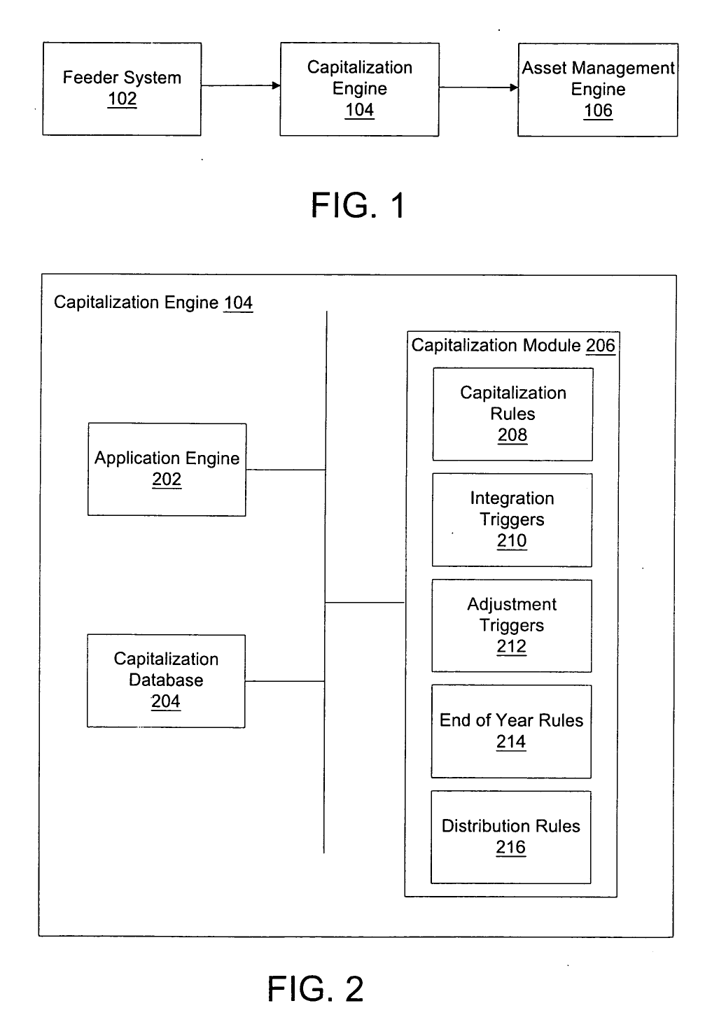

FIG. 1 is a schematic diagram of an exemplary architecture utilizing a capitalization engine 104 of the present invention. The capitalization engine 104 is coupled to a feeder system 102 which provides inputs (i.e., cost and expenditures) to the capitalization engine 104. Such inputs may include billings, expenses, labor costs, and other payables charged to specific projects. Preferably, the feed system 102 is an application such as PeopleSoft® Payables or PeopleSoft® Time and Labor, that is seamlessly integrated with the capitalization engine 104, thus reducing the amount of manual data entry. Alternatively, the feeder system 102 may be a user directly inputting the data entries.

The capitalization engine 104 is further coupled to an asset management engine 106. The asset management engine 106 receives asset data after the capitalization engine 104 creates the asset. This asset data is then utilized by the asset management engine 106 for depreciation, asset control, insurance and licensing management, and a host of other asset management functions.

Referring now to FIG. 2, a block diagram of the exemplary capitalization engine 104 in accordance with an embodiment of the present invention is shown. The capitalization engine 104 comprises an application engine 202, a capitalization database 204, and a capitalization module 206. The capitalization database 204 stores inputs (i.e., costs and expenditures) received from the feeder system 102 (FIG. 1). In an alternative embodiment, the capitalization database 204, in addition to or instead of storing the inputs, also stores the asset capitalization integration rules defined for each input. In a further embodiment, the capitalization database 204 may not contain the asset integration rules for each input, but comprise pointers to the asset integration rules stored in the capitalization module 206 Although FIG. 2 only shows one capitalization database 204 for storing inputs, alternative embodiments may comprise a plurality of capitalization databases 204.

The application engine 202 applies predetermined asset capitalization integration rules to select inputs in order to create assets. The inputs are selected based on integration triggers (as will be described infra) of the asset integration rules for each input.

In one embodiment of the present invention, the application engine 202 runs at a predefined time. For example, the application engine may be scheduled to run every night. The resulting assets created by the application engine 202 are subsequently sent to the asset management engine 106 (FIG. 1). The application engine 202 also allows for the automatic defaulting or cascading of asset integration rules from the business unit to projects within the business unit and from a project to activities within the project. The automatic defaulting function will be described in more detail infra. In alternative embodiments, the application engine 202 may only perform asset creation, while a separate engine performs the automatic defaulting function.

The capitalization module 206 stores a plurality of asset integration modules which contain all asset capitalization integration rules. The capitalization module 206 comprises capitalization rules 208, integration triggers 210, adjustment triggers 212, end of the year rules 214, and distribution rules 216. Alternative embodiments may contain more or less asset integration modules or other asset integration modules.

The capitalization rules 208 specify how to derive an asset definition. In this exemplary embodiment, the user may choose the capitalization rules 208 from a list comprising one asset per activity, one asset from many activities, many assets from many activities, and many assets from each activity. Alternatively, the user may select to manually define the asset definition.

Based on the selected capitalization rule 208, corresponding distribution rules 216 may be applied. These distribution rules 216 determine how to distribute costs from one activity to a plurality of assets. The distribution rules 216 include, but are not limited to, percentages at either a project level or an activity level, which specifies a percentage breakdown for each project or activity, respectively. Additionally, the distribution rules 216 comprise quantity distribution at either the project or activity level, which specifies a number of assets that will result from each project or activity, respectively. Alternative embodiments may further comprise distribution rules 216 based on actual transaction costs or a field combination at either the project or activity level. The field combination specifies transaction fields that can be used to identify a unique asset. Each unique combination of the specified transaction fields will result in creation of a new asset. Other distribution rules 216 may be contemplated and utilized in the present invention.

The integration triggers 210 determine timing of asset creation (i.e., when the application engine 202 will apply asset integration rules to an expenditure input) and subsequent forwarding of the created asset to the asset management engine 106. In an exemplary embodiment, the integration triggers 210 include, but are not limited to, manual, asset in service date, general in service date, project status, project percent complete, activity status, and activity percent complete. The manual integration trigger will not capitalize the input (i.e., cost and expenditure) until a user reviews the input and manually triggers capitalization. Capitalization on a specified date is activated by the asset in service date integration trigger. The project status and activity status integration triggers will capitalize an input when the project or activity reaches a specified status. For example, capitalization may be set to occur when a project or activity has a “complete” status. Alternatively, the project and activity percent complete integration trigger will capitalize when a specified percentage of the project or activity, respectively, is completed. For example, capitalization may be set to occur when an activity is 65% complete. In alternative embodiments, other integration triggers may be utilized, such as multiple dates for integration within a year.

The adjustment triggers 212 determine treatment of future expenditures that come into a project after the asset has already been capitalized. The user may select from an automatic adjustment trigger which adjusts every time the application engine 202 runs, or a manual adjustment trigger. The manual adjustment trigger will require the user to review and select entries before further capitalization to the asset.

The end of the year rules 214 specify how to handle adjustments that occur after close of a financial period. The user may choose to ignore an end of year (i.e., adjustments will occur as though no new financial period has occurred), create parent/child assets, create new assets, or stop sending adjustments after close of the financial period. According to an exemplary embodiment of the present invention, a parent asset comprises an existing asset from a previous financial period, whereas a child asset contains adjustments in a new financial period. The financial period is defined by the user and can comprise any period of time (i.e., does not need to be a year in length).

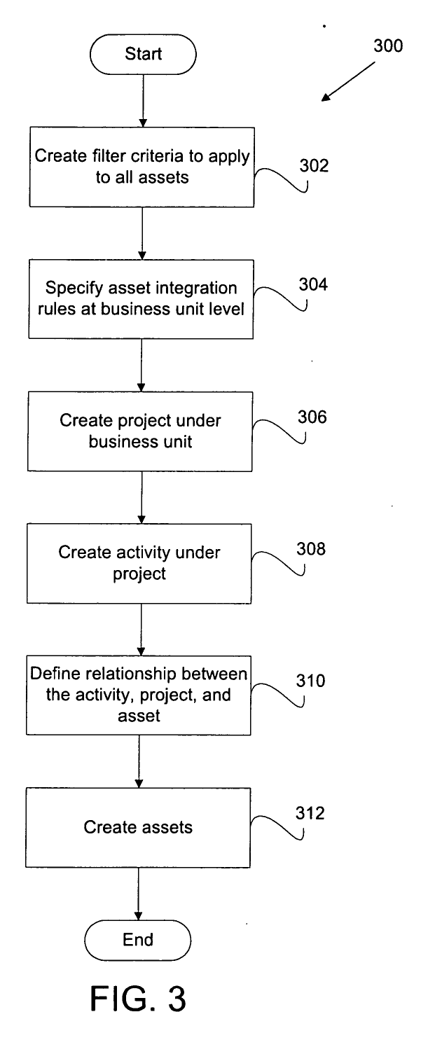

Referring now to FIG. 3, a flowchart illustrating a process for defining and applying asset capitalization integration rules in accordance with an embodiment of the present invention is shown. Initially, a filter criteria is created which is applicable to assets in a business unit in step 302. This filter criteria defines which transactions (i.e., cost and expenditure inputs) are allowed for the assets and how to create assets out of various projects. For example, a business unit may allow direct labor and materials to be capitalized, but will not allow overhead, such as administrative staff, to be included. Because the filter criteria is typically universal throughout the business unit, the filter criteria is usually created only once when the business unit is created. In further embodiments, a plurality of filter criteria may be created for the business unit, and a user may select from the plurality of filter criteria when defining the asset capitalization integration rules.

In step 304, asset capitalization integration rules are defined at a business unit level. A business unit is the highest unit within the business entity with general asset integration rules. The business unit is not necessarily a legal entity or in one-to-one correspondence with a general ledger. As previously discussed in connection with FIG. 2, these asset integration rules define the rules and triggers that will be applied to transaction expenditures, how the asset relates to a project and activity, timing of asset creation, and timing of adjustment of the asset. The asset integration rules will subsequently cascade down (i.e., automatically default) through the various projects and activities created within the business unit.

In step 306, a project is created within the business unit of step 304. The project is typically a large undertaking by the business unit. For example, the project may be a power plant. Upon creation of the project, the asset integration rules defined at the business unit level in step 304 are defaulted down to the project by the application engine 202 (FIG. 2). Thus, the project will automatically have the same asset integration rules as the business unit within which the project is created, eliminating the need for any user intervention. However, if the user desires to override one or more of the asset integration rules for the project, the user may do so. The override of one or more asset integration rules at the project level will not affect the asset integration rules established at the business level, nor will the override affect asset integration rules of other projects within the same business unit.

In step 308, an activity is created within the project. Continuing with the power plant example, activities may comprise a generator and a dam. Upon creation of the activity, the asset integration rules specified for the project are defaulted down to the activity by the application engine 202. Therefore, the activity will automatically have the same asset integration rules as the project within with the activity is created, thus eliminating the need for any user intervention. As with the project, a user may override one or more of the asset integration rules for the activity if necessary. The override of one or more asset integration rules at the activity level will not affect the asset integration rules established at the business or project levels. The override also will not affect asset integration rules of other activities within the same project.

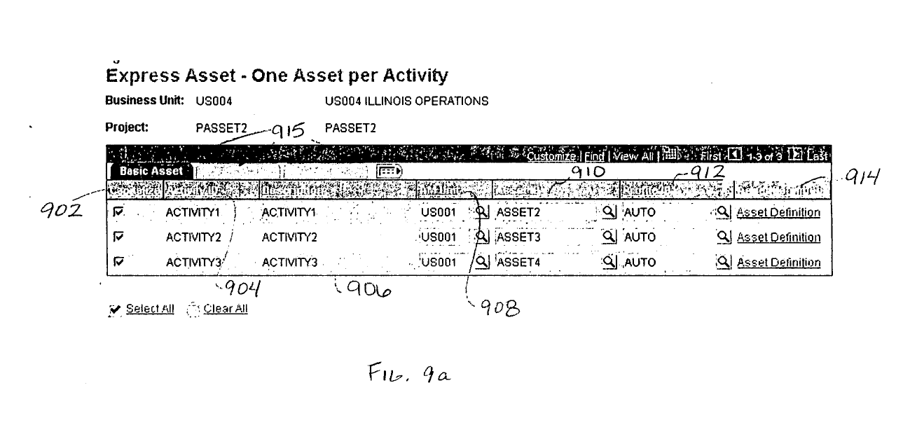

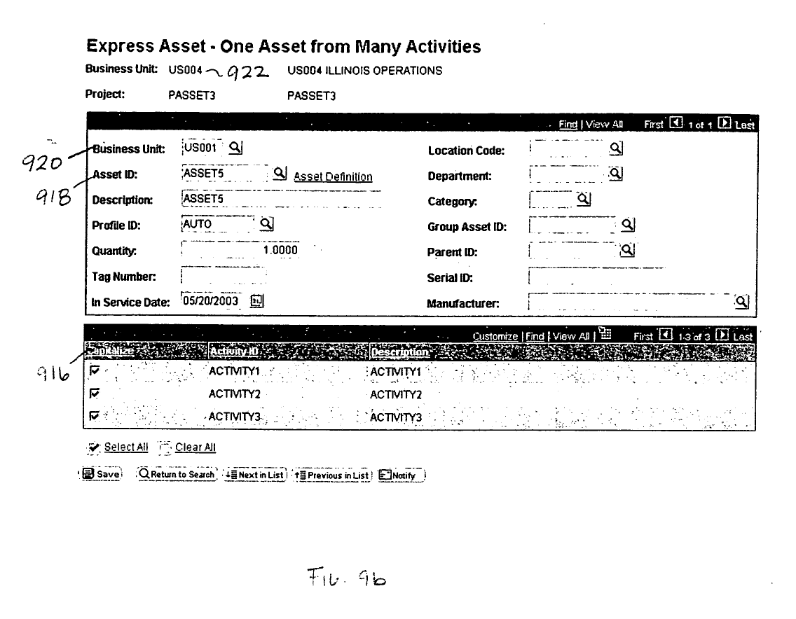

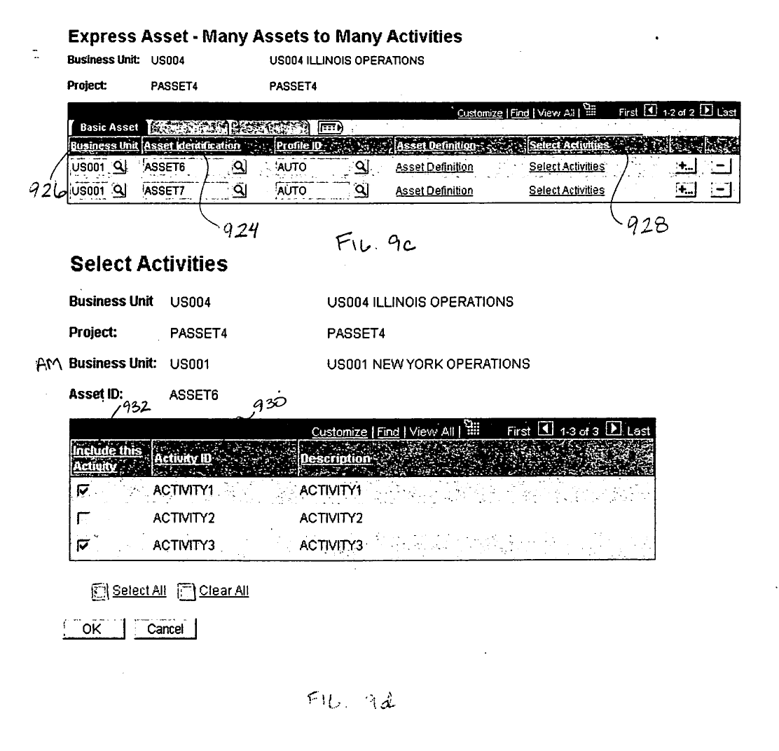

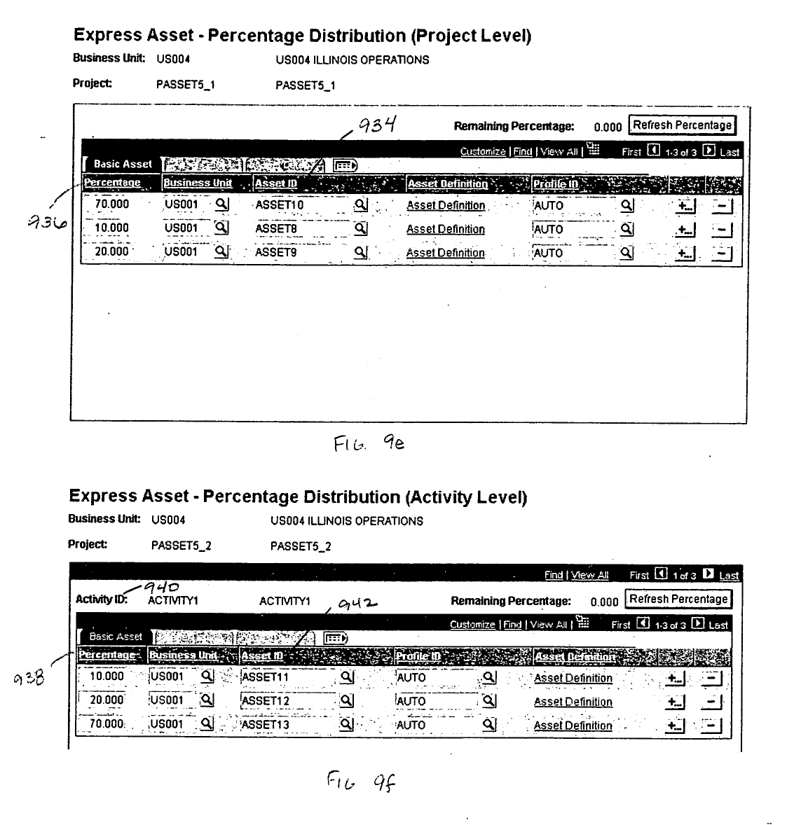

In optional step 310, distribution relationships between various activities, projects, and assets are defined. For example, if the capitalization rule is one asset per activity, then the distribution relationship is one asset per activity. These distribution relationships will be discussed in more detail in connection with FIG. 9a-FIG. 9f.

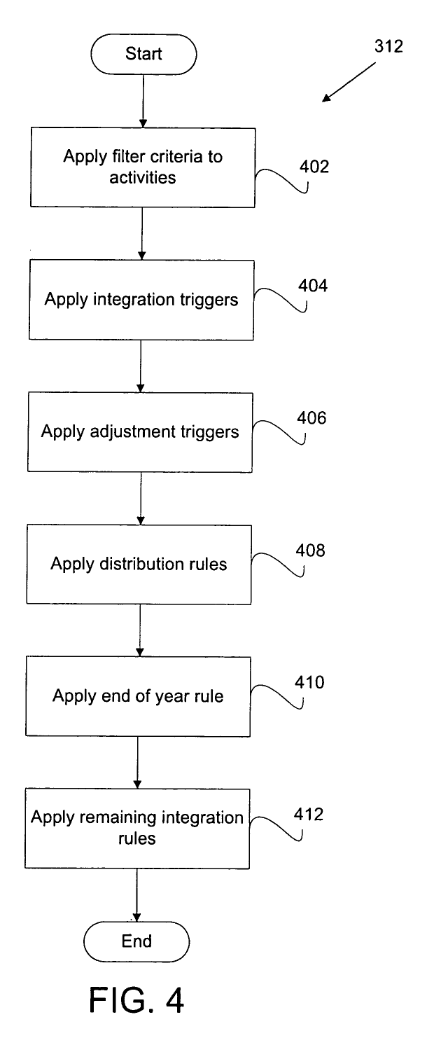

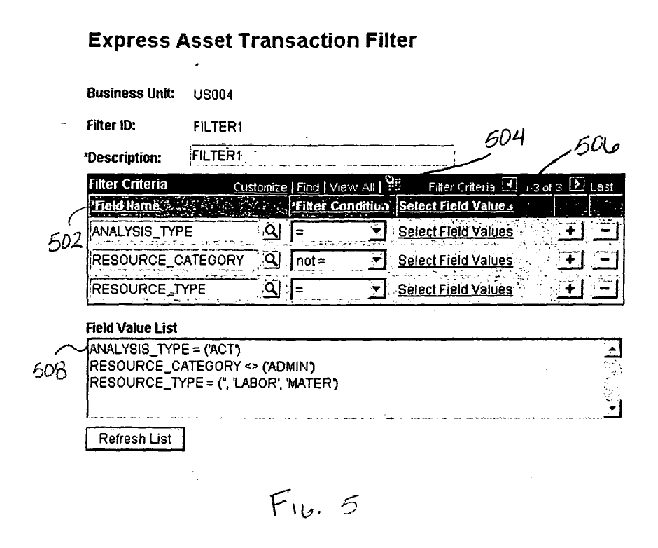

In step 312, assets are created. When the application engine 202 runs at its predefined time, the asset integration rules are applied to the various activities and projects, based on timing established by the integration triggers, to create the assets. This asset creation step will be discussed in more detail in connection with FIG. 4. In alternative embodiments of the present invention, the steps of the method of FIG. 3 may be performed in a different order, or some steps may not be necessary.

Referring now to FIG. 4, the asset creation step 312 of FIG. 3 is discussed in more detail. The application engine 202 (FIG. 2) initially applies the filter criteria in step 402. The filter criteria filters transaction costs that are allowed for each asset. For example, the filter criteria may only allow the capitalization of direct labor and material costs while not allowing the capitalization of administrative overhead.

In step 404, the application engine 202 reviews the integration trigger for any new inputs (i.e., costs and expenditures) to determine if timing allows for a new asset to be created. In one embodiment of the present invention, asset creation may be triggered manually by a user. Alternatively, asset creation may be triggered by the asset in service date, project or activity reaching a predetermined status, or project or activity reaching a predetermined percentage completed.

In step 406, adjustment triggers are reviewed for any existing assets to determine if the existing asset should be automatically adjusted. Adjustments may be necessary if new expenditures are submitted after the asset has previously been capitalized. These adjustments may be triggered either manually by the user or automatically when the application engine 202 runs.

In step 408, the application engine 202 applies distribution rules, if necessary, to the expenditure. These distribution rules spread transaction costs across multiple assets. The distribution rules may comprise percentages at either a project or activity level, quantity distribution at either a project or activity level, actual transaction expenditures, or field combinations.

End of year rules are applied by the application engine 202 in step 410. The end of year rules will properly account for sending adjustments to assets after the end of a financial year. Finally in step 412, remaining integration rules, if applicable, are applied to correctly create and account for assets. Examples of these remaining integration rules include rules on different transaction load types which may cause different processing in asset management and rules on where and how data is sent to asset management.

Further embodiments of the present invention may perform the steps of FIG. 4 in a different order. For example, the review of the integration trigger (step 404) may be performed before the application of the filter criteria (step 402). Thus, if the integration trigger is not true, then the filter criteria is not applied for the new inputs.

The process for defining and applying asset capitalization integration rules in accordance with an embodiment of the present invention will now be discussed in conjunction with exemplary screen shots applied to an example business unit (i.e., US004 Illinois Operations) in the following FIG. 5 through FIG. 9f. This example is for illustrative purposes only. The present invention may be applied to any business unit, project, or activity.

Referring now to FIG. 5, a screen shot showing an exemplary asset transaction filter page in accordance with an embodiment of the present invention is shown. This asset transaction filter page allows for definition of filter criteria for the business unit which generically defines which transactions (e.g., transaction rows) are allowed to be capitalized into assets. For example, a given company may only allow resource rows with labor and material resource types to be summarized into the asset. Because the filter criteria are created at the business unit level, each project within the business unit will inherit the business unit filter criteria. Subsequently, each activity within the project will inherit the filter criteria from the project. No user interaction is required unless there is a need to override one or more criteria.

In the exemplary asset transaction filter page, the filter named “FILTER1” is created for the US004 business unit (i.e., step 302 of FIG. 3). As shown in a field name 502 column, ANALYSIS_TYPE is set to equal to ‘ACT’ (i.e., actual costs) in a select field values 506 entry. This element of the filter criteria only allows actual costs or expenditures to be capitalized for this business unit. Further, RESOURCE_CATEGORY in the field name 502 column is set to not equal ‘ADMIN’ in the select field values 506 column, thus administrative resource categories are not allowed to be capitalized. Finally, RESOURCE_TYPE in the field name 502 column is equal to ‘LABOR’,‘MATER’ in the select field values 506 column, which indicates that the resource types allowed to be capitalized according to FILTER1 are labor and material. Other fields may be utilized in the present invention according to the needs of the business. According to the present embodiment, because multiple select field values 506 may be selected for each field name 502 entry (e.g., ‘LABOR’ and ‘MATER’ for RESOURCE_TYPE), values are not displayed in the select field values 506 column. By selecting one of the select field values 506 entries corresponding to a particular field name 502, a pop up window will provide a user with a list of possible values to select from. Alternatively, the user may manually enter values. A field value list display window 508 is provided which summarizes all the fields of the filter criteria and their corresponding field values. Alternative embodiments may display filter criteria in a different fashion.

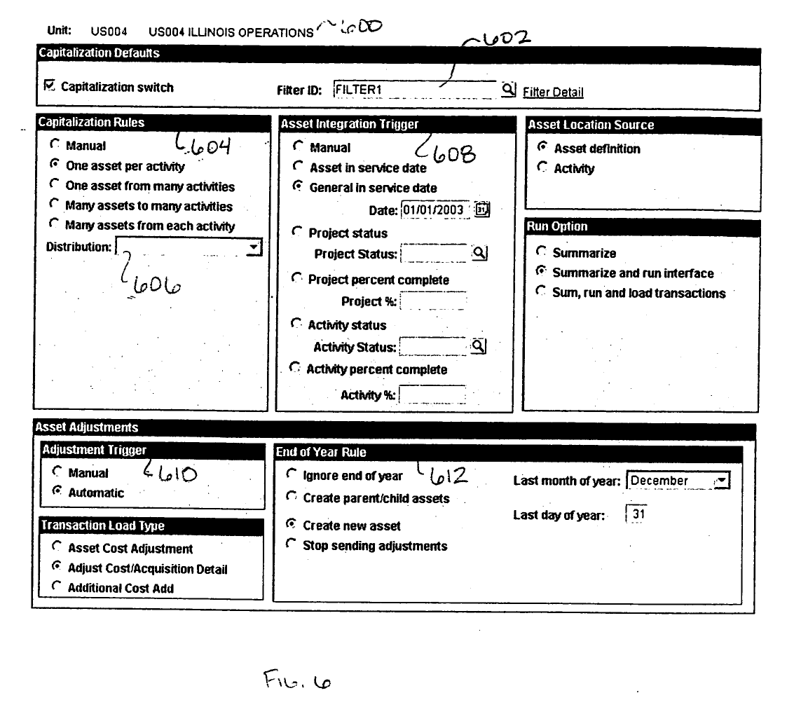

FIG. 6 illustrates a screen shot of an exemplary business unit asset options page in accordance with an embodiment of the present invention. A user may specify asset integration rules for the business unit (i.e., step 304 of FIG. 3) at any time (e.g., at the creation of the business unit, before a first project of the business unit, etc.). In a header portion 600, the business unit is identified (i.e., US004 Illinois Operations, hereinafter “the US004 business unit”). As shown in a filter ID display 602, the filter criteria created in FIG. 5 for this specific business unit is selected in the business unit asset options page. Further, a capitalization rule 604 is set by a user to “one asset per activity”. Because the capitalization rule 604 is “one asset per activity”, a distribution 606 entry is not required.

Further, an asset integration trigger 608 is set by the user to a general in service date of Jan. 1, 2003. Thus, the asset integration will occur on this date. Asset adjustments will occur automatically as indicated in an adjustment trigger 610, and new assets are created based on an end of the year rule 612 whereas the end of the year is set to December 31st. Further fields are provided on the exemplary business unit asset options page to direct where and how data is sent to asset management.

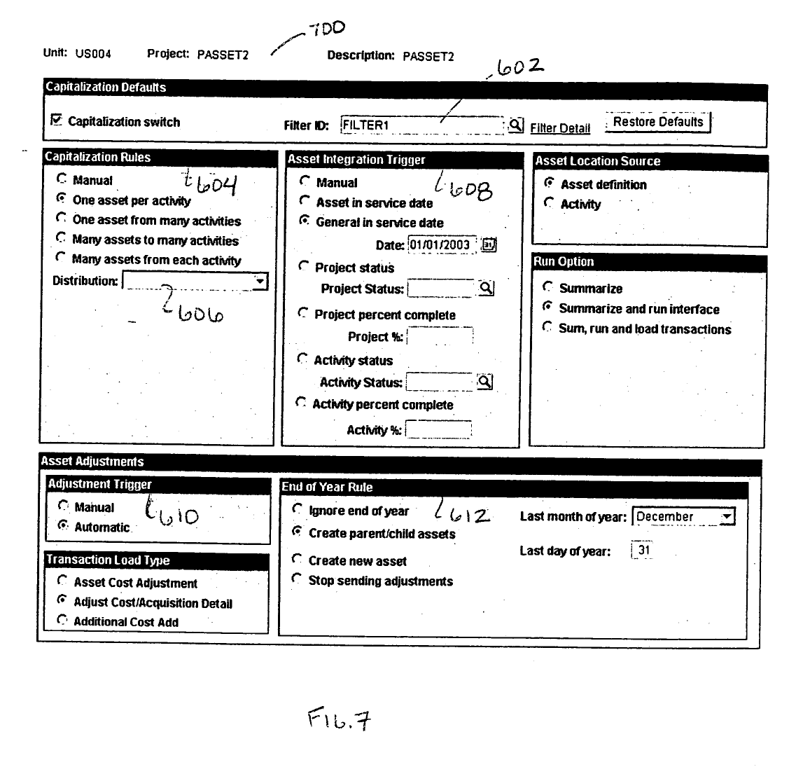

Referring now to FIG. 7, a screen shot of an exemplary project asset options page is shown. The project created within the US004 business unit (i.e., step 306 of FIG. 3) is named PASSET2 as labeled in a header 700 of the screen shot. Because the present invention automatically defaults the asset integration rules of the business unit to the project, the PASSET2 project, upon creation, has the same asset integration rules as defined in FIG. 6 for the US004 business unit. In one embodiment, the automatic defaulting is performed by the application engine 202 (FIG. 2). Therefore, PASSET2 with filter ID 602 FILTER1 has a capitalization rule 604 of “one asset per activity” which does not require a distribution rule 606. Additionally, the asset integration will trigger on the in service date of Jan. 1, 2003 with the automatic adjust trigger 610.

However, a user may manually override any of the asset integration rules at this project level. In the present example, the end of year rule 612 is changed to “create parent/child assets.” This change to the asset integration rules at the project level will not affect the defined asset integration rules at the business unit level (i.e., will not change the asset integration rules of FIG. 6), nor will the change affect asset integration rules for any other projects within the same business unit (e.g., PASSET1 of the US004 business unit, etc.). The override to the asset integration rules only applies to PASSET2.

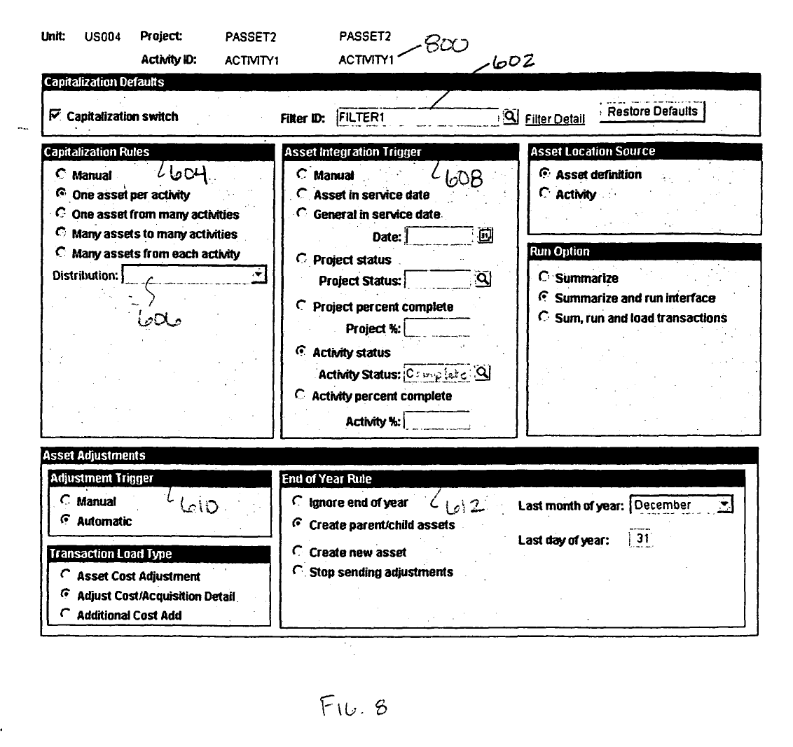

Referring now to FIG. 8, a screen shot of an exemplary asset options page is shown. The activity, named ACTIVITY1 as displayed in the header 800, is created within the project PASSET2 of FIG. 7 (i.e., step 308 of FIG. 3). Based on the automatic default functionality of the present invention, activity ACTIVITY1 will automatically receive the same asset integration rules as project PASSET2. In one embodiment, the automatic defaulting is performed by the application engine 202 (FIG. 2). Resultantly, ACTIVITY1 with filter ID 602 FILTER1 has a capitalization rule 604 of “one asset per activity” which does not require a distribution rule 606. Additionally, the adjust trigger 610 is automatic, and the end of year rule 612 will create parent/child assets after December 31st.

The user may manually override any of these asset integration rules at the activity level if so desired. In the present example, the integration trigger 608 is changed to ‘activity status’ with a condition that the activity status be “complete”. Thus, timing of asset creation will occur when the status of the activity ACTIVITY1 is complete. This change at the activity level will not affect the defined asset integration rules at either the business unit level (i.e., the US004 business unit asset integration rules of FIG. 6) or the project level (i.e., the project PASSET2 asset integration rules of FIG. 7), nor will the change affect asset integration rules for any other activities within the same project PASSET2. The change only applies to ACTIVITY1.

While the exemplary screen shots of FIG. 6-FIG. 8 only illustrate one override at each stage of the project/activity, it should be noted that any number of overrides may be performed at each stage. Alternatively, no overrides may be performed, in which case, user interaction is minimal or none.

FIG. 9a-FIG. 9f are screen shots showing exemplary asset distribution pages in accordance with embodiments of the present invention. Based on the selected capitalization rule 604 (FIG. 8), corresponding asset distribution pages, also called ‘express pages,’ will be generated and provided to the user by the application engine 202 (FIG. 2). These express pages allow the user to define relationships between the activities, projects, and assets (step 310 of FIG. 3). As shown, the express pages indicate names and a number of assets to create as well as the projects and activities that will contribute transaction expenditures to each asset. The following exemplary express pages contain many of the same fields. Thus, the following description will only discuss a particular field in great detail in the first instance. In a further embodiment of the present invention, an engine separate from the application engine 202 may generate the following express pages.

FIG. 9a shows an exemplary express page for the capitalization rule 604 (FIG. 6) of “one asset per activity.” In this embodiment, each activity (i.e., ACTIVITY1, ACTIVITY2, ACTIVITY3) within the project (i.e., PASSET2) will generate a new asset. Values and entries on this exemplary express page may populate from default values in effect at the activity level. Changes to the default values in these grids may be changes to the activity level defaults.

The exemplary express page of FIG. 9a comprises seven fields for each activity. A capitalize field 902 allows for selection of the activities which may be capitalized. If the activity cannot or should not be capitalized, then the capitalize field 902 is not selected. An activity ID field 904 and a description field 906 list the name of the activity and its description. An AM unit field 908 specifies an asset management unit in the asset management engine 106 (FIG. 1) the created assets will be forwarded to post-integration. In the present example, all three activities will be sent to US001 asset management unit. An asset ID field 910 identifies a name of the asset the activity will be capitalized into (e.g., ACTIVITY1 will be capitalized into ASSET2). A profile ID field 912 identifies standard depreciation criteria for an asset type and its corresponding asset book (as defined in the asset management engine 106 of FIG. 1). Profiles are created for all major asset categories such as land, furniture and fixtures, machinery and equipment, and automobiles. This profile ID field 912 provides (e.g., automatically) an asset category and default asset information to the asset management engine 106 (FIG. 1). Finally, an asset definition field 914 is a hyperlink to a more detailed asset definition page. This asset definition page may include such information as the transaction date, accounting data, in service date, department, cost type, and other data describing the asset. Tabs 915 located on the express page allow for most popular fields for customer use to be easily and quickly accessed. Alternative embodiments may comprise more, less, or other fields.

If the “one asset from many activities” capitalization rule is selected, then the exemplary express page of FIG. 9b may be provided. Most of the default values will be locked at the activity level if “one asset from many activities” is selected at the project level, and changes at the activity level will not be available (i.e., defaults related to this distribution cannot be changed at the activity level).

In this example, every activity (i.e., ACTIVITY1, ACTIVITY2, ACTIVITY3) that allows for capitalization within the project will be utilized to generate a single asset as indicated by a marked capitalize field 916. The single asset these activities will integrate into is ASSET5 as specified in an asset ID field 918. In this embodiment, ASSET 5 is located in asset management engine 106 (FIG. 1) business unit US001 as indicated in the asset management business unit field 920. Thus, the asset management business unit (i.e., US001 unit) differs from the project business unit (i.e., US004 unit 922) in the capitalization engine 104 (FIG. 1). Alternative embodiments may have asset management business units that match their respective project business units.

FIG. 9c shows an exemplary express page when the “many assets from many activities” capitalization rule is selected. Similar to the “one asset from many activities” option, the “many assets from many activities” option will derive assets from one or more activities that make up a project. In the present embodiment, the user may specify creation of more than one asset wherein each asset comprises one or more activities and each activity may only contribute to one asset. Further, most of the default values will be locked at the activity level if “many assets from many activities” is selected at the project level (i.e., defaults to distribution cannot be changed at the activity level).

In the present example, two assets (i.e., ASSET6 and ASSET7) will be created as specified in an asset identification field 924 for asset management business unit US001 as specified in an asset management business unit field 926. In order to view which activities within the project business unit (i.e., business unit US004) are assigned to which asset, the user may select a “select activity” hyperlink 928. This selection will provide an exemplary select activities page as shown in FIG. 9d.

FIG. 9d illustrates the select activities page for ASSET6 from FIG. 9c. As shown in this example, only ACTIVITY1 and ACTIVITY3 (in an activity ID column 930) from project business unit US004, project PASSET4 will be capitalized into ASSET6 in asset management business unit US001 as indicated in an ‘include this activity’ column 932. ACTIVITY2 is not selected for capitalization into ASSET6.

Referring now to FIG. 9e, an exemplary express page at a project level is shown for an embodiment wherein the “many assets from each activity” capitalization rule and “percentage” distribution rule are selected. Thus, this embodiment utilizes percentages to divide total transaction expenditures and costs from each activity across assets indicated on the express page. For example, ASSET10 in an asset id 934 entry will receive 70% of the total expenditures for project PASSET5 as shown in a percentage 936 entry, while ASSET8 will receive 10% of the total expenditures from PASSET5. The total percentage must equal 100% before the capitalization engine 104 (FIG. 1) will capitalize the assets.

Similarly, FIG. 9f illustrates an exemplary express page at an activity level for a “percentage” distribution rule under the “many assets from each activity” capitalization rule. As with the project level embodiment, the activity level embodiment must have a total distribution percentage of 100% in order for the assets to be capitalized. Thus in the present example, 10% of expenditures as indicated in a percentage 938 entry for activity ID 940 ACTIVITY1 will result in ASSET11 as indicated in an asset ID 942 entry, 20% of expenditures for ACTIVITY1 will result in ASSET12, and 70% of expenditures for ACTIVITY1 will result in ASSET13.

There is an advantage in creating percentage distribution at both the project and activity levels. At the project level, all activities will contribute according to the set percentage, and the number of assets created will be limited to those specified under the project. Thus, the system will not create an asset for each activity in this case. For example, if the user specifies the percentage at the project level be 10% and 90%, then two assets will be created. Each activity within the project will contribute 10% to the first asset and 90% to the second asset. However, if the user specifies the percentage distribution at the activity level at 10% and 90% for each of two activities, then four assets will be created.

Activity will contribute 10% to asset1 and 90% to asset2, while activity2 will contribute 10% to asset3 and 90% to asset4.

The exemplary express page screen shots of FIG. 9a-9f are illustrative according to embodiments of the present invention. It should be noted that the layouts and fields of the express pages may be organized in a different fashion and other fields may be utilized. Additionally, other distribution rules not shown in express page examples are contemplated by the present invention.

The present invention has been described above with reference to exemplary embodiments. It will be apparent to those skilled in the art that various modifications may be made and other embodiments can be used without departing from the broader scope of the invention. Therefore, these and other variations upon the exemplary embodiments are intended to be covered by the present invention.

What is claimed is:

1. A method for defining and relating activities and projects to at least one asset for capitalization, comprising:
specifying asset integration rules for a business unit;
creating at least one project within the business unit;
automatically defaulting the asset integration rules from the business unit to the at least one project;
creating at least one activity within the at least one project; and
automatically defaulting the asset integration rules from the at least one project to the at last one activity.

2. The method of claim 1 wherein specifying the asset integration rules further comprises specifying a capitalization rule for determining a relationship between the at least one activity with the one asset.

3. The method of claim 2 further comprising defining distribution rules if the at least one activity creates a plurality of assets.

4. The method of claim 1 wherein specifying the asset integration rules further comprises specifying an asset integration trigger for determining timing for capitalization.

5. The method of claim 1 wherein specifying the asset integration rules further comprises specifying an adjustment trigger for determining treatment of future activities after the at least one asset has been capitalized.

6. The method of claim 1 wherein specifying the asset integration rules further comprises specifying an end of year rule for determining how adjustments occur after close of a financial time period.

7. The method of claim 1 wherein creating at least one project further comprises overriding a rule of the asset integration rules defaulted from the business unit.

8. The method of claim 1 wherein creating at least one activity further comprises overriding a rule of the asset integration rules defaulted from the at least one project.

9. The method of claim 1 further comprising specifying filter criteria for the business unit for defining types of transactions allowed to be capitalized.

10. The method of claim 1 further comprising customizing an express page describing at least one relationship between the at least one activity with the at least one asset.

11. A system for defining and relating activities and projects to at least one asset for capitalization, comprising:
a capitalization module containing generic asset integration rules;
an application engine configured for specifying asset integration rules for a business unit based on the generic asset integration rules, automatically defaulting the asset integration rules from the business unit to at least one project created within the business unit, and automatically defaulting the asset integration rules from the at least one project to at least one activity created within the at least one project; and
a capitalization database for storing business unit, project, and activity inputs.

12. The system of claim 11 wherein the capitalization module comprises capitalization rules for determining a relationship between the at least one activity and the at least one asset.

13. The system of claim 12 wherein the capitalization module comprises distribution rules for application to the at least one activity if the at least one activity creates a plurality of assets.

14. The system of claim 11 wherein the capitalization module comprises asset integration triggers for determining timing for capitalization.

15. The system of claim 11 wherein the capitalization module comprises adjustment triggers for determining treatment of future activities after the at least one asset has been capitalized.

16. The system of claim 11 wherein the capitalization module comprises end of the year rules for determining how adjustments occur after close of a financial time period.

17. The system of claim 11 wherein the application engine is further configured to allow overriding of a rule of the asset integration rules defaulted from the business unit to the at least one project.

18. The system of claim 11 wherein the application engine is further configured to allow overriding of a rule of the asset integration rules defaulted from the at least one project to the at least one activity.

19. A computer-readable medium having embodied thereon a program, the program being executable by a machine to perform a method for defining and relating activities and projects to at least one asset for capitalization, comprising:
specifying asset integration rules for a business unit;
creating at least one project within the business unit;
automatically defaulting the asset integration rules from the business unit to the at least one project;
creating at least one activity within the at least one project; and
automatically defaulting the asset integration rules from the at least one project to the at last one activity.

20. A system for defining and relating activities and projects to at least one asset for capitalization, comprising:
means for specifying asset integration rules for a business unit;
means for creating at least one project within the business unit;
means for automatically defaulting the asset integration rules from the business unit to the at least one project;
means for creating at least one activity within the at least one project; and means for automatically defaulting the asset integration rules from the at least one project to the at last one activity.

21. A method for generating at least one asset for capitalization, comprising:
specifying asset integration rules for a business unit;
creating at least one project within the business unit;
automatically defaulting the asset integration rules from the business unit to the at least one project;
creating at least one activity within the at least one project;
automatically defaulting the asset integration rules from the at least one project to the at least one activity; and
applying the asset integration rules to the at least one activity and the at least one project to create the at least one asset.

22. A computer-readable medium having embodied thereon a program, the program being executable by a machine to perform a method for generating at least one asset for capitalization, comprising:
specifying asset integration rules for a business unit;
creating at least one project within the business unit;
automatically defaulting the asset integration rules from the business unit to the at least one project;
creating at least one activity within the at least one project;
automatically defaulting the asset integration rules from the at least one project to the at least one activity; and
applying the asset integration rules to the at least one activity and the at least one project to create the at least one asset.
